(19) United States
(12) Patent Application Publication
(10) Pub. No.: US 2010/0014054 A1
(43) Pub. Date: Jan. 21, 2010

(54) PROJECTION DISPLAY APPARATUS FOR SUPPRESSING SPECKLE NOISE

(75) Inventors: Anatoliy Lapchuk, Suwon-si (KR); Haeng-Seok Yang, Bucheon-si (KR); Victor Yurlov, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/330,211

(22) Filed: Dec. 8, 2008

(30) Foreign Application Priority Data
Jul. 21, 2008 (KR) 10-2008-0070827

(51) Int. Cl. G02B 27/48; G03B 21/28

(52) U.S. Cl. 353/20

(57) ABSTRACT

A projection display apparatus of the present invention can include a light source; an optical modulator, configured to repeatedly output a modulation beam N times in a predetermined time range, the modulation beam being generated by identically modulating a bema of light emitted from the light source and N being a nature number and equal to or greater than 2; a mirror, configured to reflect the modulation beam, which is repeatedly outputted N times, to scan the modulation beam to an identical point of a screen; and a polarization rotating unit, configured to rotate a polarization direction of the modulation beam for each time the modulation beam is scanned. With the present invention, the speckle noises on a video scanned to a screen can be suppressed.

### CROSS-REFERENCE TO RELATED APPLICATIONS

This application claims the benefit of Korean Patent Application No. 10-2008-0070827 filed with the Korean Intellectual Property Office on Jul. 21, 2008, the disclosure of which is incorporated herein by reference in its entirety.

### BACKGROUND

1. Technical Field

The present invention relates to a projection display apparatus, more specifically to a projection display apparatus that can suppress speckle noises.

2. Description of the Related Art

Projection display apparatuses that employ a laser as their light sources are popular. The projection display apparatus can realize not only extra-large videos but also extra-small videos. It is very difficult that typical liquid crystal displays (LCD) or plasma display panels (PDP) realize the extra-large videos.

However, since such a projection display apparatus modulates a beam emitted from a laser light source per pixel and scans the beam to a screen in order to form a video, the formed video has a lower quality than those of other display apparatuses in which their screens directly emit rays of light.

One of the reasons that the formed video has the lower quality is resulted from a speckle noise or a speckle pattern generated on the video formed by a laser projection display apparatus.

The coherence of laser beams causes several interference patterns to be generated on a screen. If any distance between the interference patterns is beyond 1 mm, a user recognizes the interferences as noises.

For example, if a screen is scanned at the distance of about 3 m, the size of any pixel are likely to be beyond 1 mm. This generates not the same brightness in the pixel but the speckle patterns. Human eyes recognize the speckle patterns and watch the formed video having noises. As a result, it is said that the quality of the video is significantly deteriorated.

### SUMMARY

Accordingly, the present invention, which is contrived to solve the aforementioned problems, provides a projection display apparatus that can suppress speckle noises of a screen by time-dividedly rotating the direction of a polarized beam of light.

Other problems that the present invention solves will become more apparent through the following description.

To solve the above problems, an aspect of the present invention features a projection display apparatus.

According to an embodiment of the present invention, the projection display apparatus can include a light source; an optical modulator, configured to repeatedly output a modulation beam N times in a predetermined time range, the modulation beam being generated by identically modulating a bema of light emitted from the light source and N being a nature number and equal to or greater than 2; a mirror, configured to reflect the modulation beam, which is repeatedly outputted N times, to scan the modulation beam to an identical point of a screen; and a polarization rotating unit, configured to rotate a polarization direction of the modulation beam for each time the modulation beam is scanned.

The predetermined time range can be smaller than a time resolution of a human vision system (HVS).

The optical modulator can be a one-dimensional optical modulator that outputs a linear modulation beam, and the mirror can be a scanning mirror that forms a two-dimensional video by scanning a linear modulation beam, repeatedly outputted N times, to the screen. Here, the polarization rotating unit can rotate a polarization direction of the linear modulation beam for each time the linear modulation beam is scanned.

The light source can include a red light source, a green light source, and a blue light source, and the red, green, and blue light sources can output each beam according to a predetermined order.

The light source can output beams at a period of a set of beams consisting of a red beam, a green beam, and a blue beam at least once; and the optical modulator can output the modulation beam by modulating the beams N times identically at the period of a set of beams. Here, the polarization rotating unit can rotate a polarization direction of the modulation beam at the period of a set of beams.

If the modulation beam, which is outputted by identically modulating the beams N times at the period of the set of beams, is scanned to an identical point of the screen, a full-color video frame can be completely formed.

A multiple of the N of the period of the set of beams can be smaller than a period of a human time resolution

The polarization rotating unit can be a liquid crystal polarization rotating unit.

The polarization rotating beam can be placed between the mirror and the screen.

### BRIEF DESCRIPTION OF THE DRAWINGS

FIG. 1A and FIG. 1B show a brief structure of a projection display apparatus in accordance with an embodiment of the present invention;

FIG. 2 shows a shape of a micromirror constituting an optical modulator included in a projection display apparatus in accordance with an embodiment of the present invention;

FIG. 3 shows an optical modulator included in a projection display apparatus in accordance with an embodiment of the present invention;

FIG. 4 shows the structure of a projection display apparatus in accordance with an embodiment of the present invention;

FIG. 5 shows the structure of a projection display apparatus in accordance with another embodiment of the present invention;

FIG. 6 briefly shows how a projection display apparatus projects a full-color video on a screen in accordance with an embodiment of the present invention; and

FIG. 7 is a graph showing how speckle noises are suppressed in a projection display apparatus in accordance with another embodiment of the present invention.

### DETAIL DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to another element directly but also as possibly having yet another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments of the present invention will be described in detail with reference to the accompanying drawings. Identical or corresponding elements will be given the same reference numerals, regardless of the figure number, and any redundant description of the identical or corresponding elements will not be repeated.

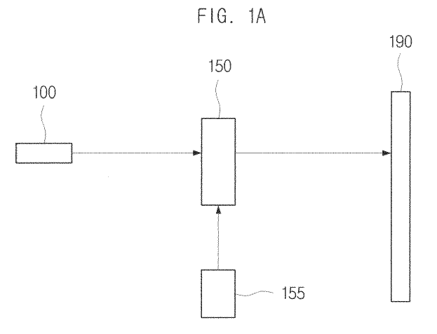

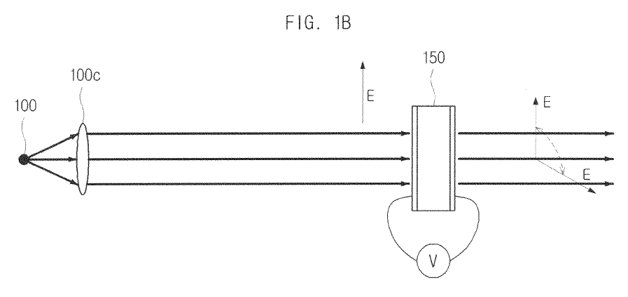

FIG. 1A and FIG. 1B show a brief structure of a projection display apparatus in accordance with an embodiment of the present invention.

As shown in FIG. 1A, the a projection display apparatus in accordance with an embodiment of the present invention can include a light source 100, a polarization rotating unit 150, and a polarization driver circuit 155.

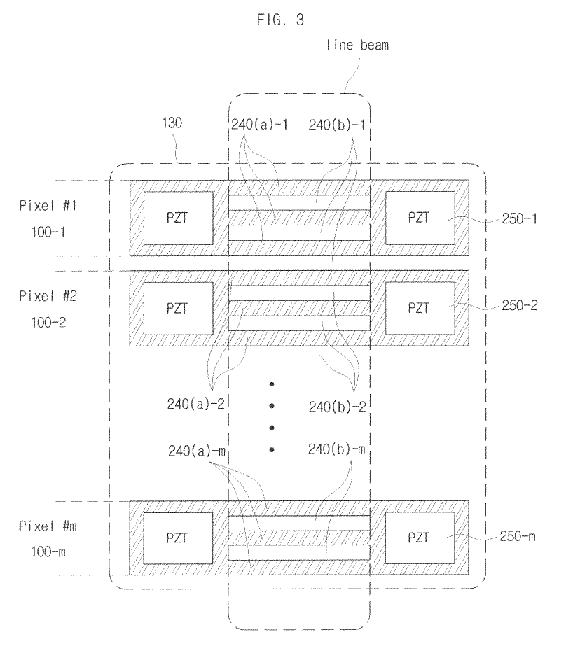

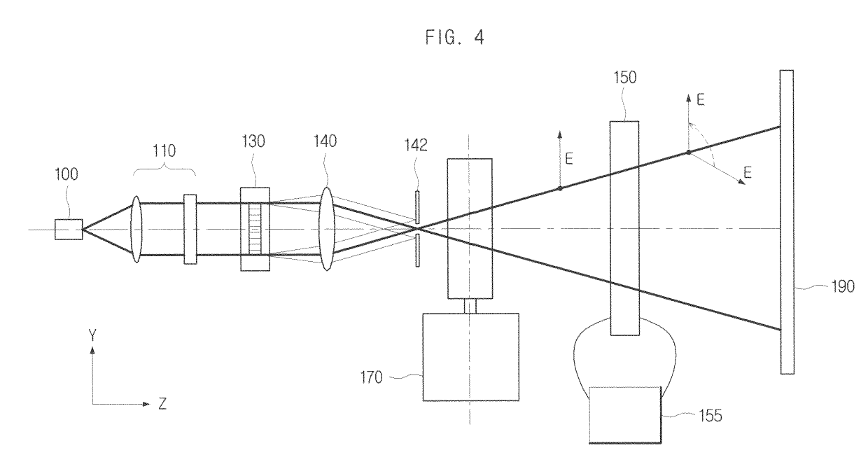

The a projection display apparatus in accordance with an embodiment of the present invention can further include a lens to be used in a lighting system, a projection lens, and a scanning mirror and an optical modulator. This will be described below with reference to FIG. 3 and FIG. 4.

As shown in FIG. 1A, the light source 100 can emit a beam of light. Herein, the light source 100 can employ a laser diode, a solid laser, a gas laser, or a liquid laser. The prevent invention is not limited to these types of laser.

The beam emitted from the light source 100 progresses to a screen 190 to form a video on the screen 190. A user can recognize the video formed on the screen 190. Due to the coherence of light, the video projected on the screen may have irregular speckle noises (or speckle patterns). In other words, since the laser beam is a coherent beam of light, this may cause the speckle noises to be generated on the projected video. If there are enough speckle noises for a human eye to recognize, the quality of video may be significantly deteriorated.

On the other hand, if N beams that are uncorrelated to each other are overlapped on a screen, the speckle noises may be suppressed by ⇄\sqrt{N} times. In other words, with the overlap of N uncorrelated beams, the speckle noises of video may drop by using \sqrt{N} as a decreasing factor.

Accordingly, the polarization rotating unit 150 of the present invention can allow the uncorrelated laser beams to be overlapped by time-dividedly rotating the polarization direction of the beams while the beams are emitted from the light source 100 to the screen 190.

For example, if the polarization rotating unit 150 of the present invention rotates the polarization direction of the beams as 90 degree (i.e. π/2) in the time period of 1/40 second, which is 1/20 or smaller second, two beams having orthogonal polarization directions can be overlapped on the screen 190 within 1/20 second.

Accordingly, a human eye can watch the screen 190 on which the speckle noises can be suppressed by \sqrt{2} times.

The uncorrelated laser beams may not be overlapped for 1/40 or smaller second. The speckle noises caused by the uncorrelated laser beams, which are not overlapped in 1/40 or smaller second, may not be recognized by a human eye. Accordingly, it is not necessary to consider the speckle noises.

The human visual system (HVS) of a human has a limited time resolution. In particular, it is said that the human eye is not able to recognize visual stimulus that are changed within 1/20 or smaller second. This is the principle that even though the interlaced scanning of the scanning lines of TV is performed from a left upper side with the frequency of 60 Hz, the human eye can recognize a full two-dimensional video. Here, the value of 1/20 second can be varied according to the human eye.

Therefore, if the uncorrelated laser beams are overlapped on a screen by using the period which is equal to or smaller than the human time resolution, the HVS may merely recognize that the speckle noises can be suppressed by \sqrt{2} times.

As shown in FIG. 1B, the projection display apparatus in accordance with an embodiment of the present invention can include the light source 100, a collimating lens 100c, and the polarization rotating unit 150. As described with reference to FIG. 1A, a beam of light emitted from the light source 100 can be converted to a parallel beam through the collimating lens 100c.

The polarization direction of the parallel-collimated beam is vertically rotated while the parallel-collimated beam passes through the polarization rotating unit 150. The polarization rotating unit 150 as shown in FIG. 1B can be a liquid crystal polarization rotating unit.

If a voltage is supplied, the polarization rotating unit 150, which is the liquid crystal polarization rotating unit, can change the arrangement of liquid crystal included in the polarization rotating unit 150 to change the polarization direction E of a beam passing through the polarization rotating unit 150 to a direction.

The “liquid crystal” of the polarization rotating unit 150 can refer to molecules in an intermediary state between perfect regularity, which is seen in a solid, and irregularity, which is often seen in an isotropic liquid.

If the liquid crystal is placed in an electrical field, the arrangement of the liquid crystal is changed. This can make it possible to polarize the beam emitted to the screen 190. In particular, once beams pass through the liquid crystal in which an electric field is acting in a direction before the beam reaches to an inner screen, the beams can be filtered by allowing some beams, which vibrate in the same direction as that of the electric field, to pass through the liquid crystal. As a result, the beams can be polarized in a predetermined direction according to the arrangement of molecules.

If the direction of the electrical field is rotated vertically to the previous direction of the electric field or the acting electrical field is removed, the beams vibrating in the direction that is vertical to the previous direction of the electrical field can pass through the liquid crystal.

Accordingly, the polarization rotating unit 150 can rotate the polarization direction according to the direction of the electric field which affects the liquid crystal polarization rotating unit 150 in the outside. Herein, the polarization driver circuit 155, as shown in FIG. 1A, can supply electric potential to allow an electric field to affect the liquid crystal polarization unit 150.

The polarization driver circuit 155 can allow the polarization of the beams having passed through the polarization rotating unit 150 to be time-dividedly vertical by forming and not forming the electric field repeatedly according to a predetermined period or changing the direction of the electric field according to a predetermined period.

In accordance with another embodiment of the present invention, the projection display apparatus can further include various elements for projecting different luminance values and different colors per each pixel forming a video and form one full-color video, instead of forming a video by directly projecting a beam emitted from the light source 100 onto the screen 190.

An optical modulator in accordance with another embodiment of the present invention can generate a modulation beam of light by modulating a beam emitted from the light source 100 in units of pixel. The generated modulation beam can be reflected by a scanning mirror to be projected onto the screen 190, and accordingly, a video can be generated on the screen 190.

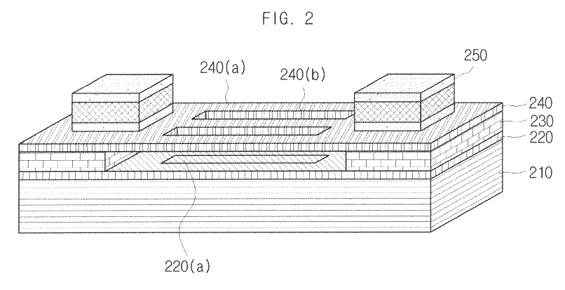

The optical modulator of modulating the luminance of a beam in units of pixel will be described below with reference to FIG. 2 and FIG. 3.

FIG. 2 shows a shape of a micromirror constituting an optical modulator included in a projection display apparatus in accordance with an embodiment of the present invention.

As shown in FIG. 2, which depicts one of a plurality of micromirrors arranged in a line to constitute an optical modulator, there shown are a substrate 210, an insulation layer 220, a sacrificial layer 230, a ribbon structure 240 and a piezoelectric element 250.

Micromirrors can be arranged in a line to form a one-dimensional optical modulator, and micromirrors can be arranged on a two-dimensional planar surface to form a two-dimensional optical modulator.

The substrate 210 can be a commonly used semiconductor substrate, and the insulation layer 220 can be deposited as an etch stop layer. The insulation layer 220 can be formed from a material with a high selectivity to the etchant (i.e. an etching gas or an etching solution) that etches the material used as the sacrificial layer 230. Here, a lower reflective layer 220(a) can be formed on the insulation layer 220 to reflect incident beams of light.

The sacrificial layer 230 can support the ribbon structure 240 at opposite sides such that the ribbon structure 240 can be spaced by a constant gap from the insulation layer 220, and form a space in a center part.

The ribbon structure 240 can create diffraction and interference in the incident light to perform optical modulation of signals. The ribbon structure 240 can be formed in a plurality of ribbon shapes, or can include a plurality of open holes 240(b) in the center part of the ribbons. The piezoelectric element 250 also controls the ribbon structure 240 to move upwardly and downwardly according to upward and downward, or leftward and rightward contraction or expansion levels generated by the voltage difference between the upper and lower electrodes. Here, the lower reflective layer 220(a) can be formed corresponding to the open hole formed in the ribbon structure 240.

For example, in case that the wavelength of a beam of light is λ, a first voltage can be supplied to the piezoelectric elements 250. At this time, the first voltage can allow the gap between an upper reflective layer 240(a), formed on the ribbon structure 240, and the lower reflective layer 220(a), formed on the insulation layer 220, to be equal to (2Λ)λ/4, Λ being a natural number. In the case of a 0^{th}-order diffracted beam of light, the overall path length difference between the light reflected by the upper reflective layer 240(a) and the light reflected by the lower reflective layer 220(a) can be equal to Λλ, so that constructive interference occurs and the diffracted light renders its maximum luminance. In the case of +1^{st} or −1^{st} order diffracted light, however, the luminance of the light can be at its minimum value due to destructive interference.

A second voltage can be supplied to the piezoelectric elements 250. At this time, the second voltage can allow the gap between an upper reflective layer 240(a), formed on the ribbon structure 240, and the lower reflective layer 220(a), formed on the insulation layer 220, to be equal to (2Λ+1)λ/4, Λ being a natural number. In the case of a 0^{th}-order diffracted beam of light, the overall path length difference between the light reflected by the upper reflective layer 240(a) formed on the ribbon structure 240 and the light reflected by the insulation layer 220(a) can be equal to (2Λ+1)λ/2, so that destructive interference occurs, and the diffracted light renders its minimum luminance. In the case of +1^{st} or −1^{st} order diffracted light, however, the luminance of the light can be at its maximum value due to constructive interference.

As a result of such interference, the micromirror can load a signal for one pixel on the beam of light by adjusting the quantity of the reflected or diffracted light. Although the foregoing describes the cases in which the gap between the ribbon structure 240 and the insulation layer 220 is (2Λ)λ/4 or (2Λ+1)λ/4, it shall be obvious that a variety of embodiments can be applied to the present invention, in which adjusting the gap between the ribbon structure 240 and the insulation layer 220 is able to control the luminance of light interfered by diffraction and/or reflection of the incident light.

Although a diffractive optical modulator has been described with reference to FIG. 2, the diffractive optical modulator is merely an optical modulator included in the projection display apparatus in accordance with an embodiment of the present invention. It shall be obviously that the diffractive optical modulator can be replaced with a transmissive or reflective optical modulator.

The piezoelectric optical modulator has also been described with reference to FIG. 2. Similarly, this is merely an example of an optical modulator in accordance with an embodiment of the present invention. It shall be obviously that the piezoelectric optical modulator can be replaced with an electrostatic optical modulator.

FIG. 3 shows an optical modulator included in a projection display apparatus in accordance with an embodiment of the present invention.

Referring to FIG. 3, the optical modulator 130 can be configured to include m micro-mirrors 100-1, 100-2, . . . , and 100-m, each of which corresponds to a first pixel (pixel #1), a second pixel (pixel #2), . . . , and an m^{th} pixel (pixel #m), respectively, m being a natural number. The optical modulator 130 can process image information with respect to 1-dimensional images of vertical or horizontal scanning lines (which are assumed to consist of m pixels), while each micro-mirror 100-1, 100-2, . . . , and 100-m can process one pixel among the m pixels constituting the vertical or horizontal scanning line.

The optical modulator 130 as shown in FIG. 3 can be a one-dimensional optical modulator. The vertical or horizontal scanning lines can be formed by one-dimensional modulation beams, to which line beams are modulated in units of pixel, the line beams being incident in the lengthwise direction in the optical modulator in which the micromirrors, as shown in FIG. 3, are arranged in a line.

The beam of light reflected or diffracted by each micro-mirror can be later projected as a 2-dimensional image onto the screen 190 by a scanner. For example, in the case of an image having a VGA resolution of 640×480, modulation can be performed 640 times for one surface of the scanner for 480 vertical pixels, to thereby generate 1 frame on the screen 190 per surface of the scanner.

In the present embodiment, it is assumed that the number of holes 240(b)-1 formed in the ribbon structure 240 is two. Because of the two holes 240(b)-1, three upper reflective layers 240(a)-1 can be formed in an upper part of the ribbon structure 240. In the insulation layer 220, two lower reflective layers can be formed in correspondence with the two holes 240(b)-1. Another lower reflective layer can also be formed in the insulation layer 220 in correspondence with the gap between the first pixel (pixel #1) and the second pixel (pixel #2). Accordingly, the number of the upper reflective layers 240(a)-1 can be identical to that of the lower reflective layers per pixel, and it can be possible to control the luminance of modulation light by using the 0^{th}-order diffracted light or ±1^{st}-order diffracted light.

FIG. 4 shows the structure of a projection display apparatus in accordance with an embodiment of the present invention.

As shown in FIG. 4, the projection display apparatus can include a light source 100, a lens unit 110, an optical modulator 130, a projection lens 240, a diaphragm 142, a scanning mirror 170, and a polarization rotating unit 150, and a polarization driver circuit 255. Here, the lens unit 110 can be used in a lighting system.

The light source 100 can be a green laser diode. Hereinafter, it is assumed that the light source 100 is the green laser diode. It shall be obvious that the light source 100 can be a red or blue light source.

Since green beams of light emitted from the green laser diode 100 are scattered in front, the green beams may be required to pass through a collimating lens. The green beams having passed through the collimating lens can be converted to parallel beams. The parallel beams can progress and pass through a cylinder lens.

The cylinder lens can be a lens made by allowing a cylinder-shaped optical material to be formed with the radius of curvature vertically or horizontally in order to convert the parallel beams to line beams. However, the present invention is not limited to the name or the structure of the cylinder lens. The cylinder lens can be replaced with an optical element that can convert a beam to a line beam by transforming the shape of the beam such that the line beam is incident on the one-dimensional optical modulator.

The lens unit 110 can include a collimating lens and a cylinder lens. The green beams can be converted to the parallel line beams by passing through the lens unit 110 before being incident on the one-dimensional optical modulator 130.

As described with reference to FIG. 3, the one-dimensional optical modulator 130, in which a plurality of micromirrors are arranged in units of pixel, can modulate the luminance of each pixel by diffracting the green beams per pixel.

The modulation beams modulated in units of pixel by the one-dimensional optical modulator 130 can progress to the diaphragm 142 through the projection lens 140. The projection lens 140 can condense the linear modulation beams modulated in units of pixel by the one-dimensional optical modulator 130 such that the linear modulation beams can pass through the diaphragm 142.

Although FIG. 4 shows that the diaphragm 142 has a single slit, the diaphragm 142 in accordance with an embodiment of the present invention is not limited to the single-slit diaphragm 142. The single-slit diaphragm 142 can be replaced with a double-slit diaphragm.

If the green modulation beams having passed through the diaphragm 142 are scanned to the screen 190, a one-dimensional linear video can be formed. This may be because in case that the one-dimensional optical modulator 130 has 480 micromirrors arranged in a line, the beam modulated by and outputted from the optical modulator 130 has information related to 480 pixels.

Accordingly, the scanning mirror 170 may be required to project the green modulation beam as a two-dimensional video onto the screen 190. The scanning mirror 170 can be a galvano mirror or a polygon mirror.

The scanning mirror 170 can scan the green modulation beam from one side to the other side of the screen 190. For example, in the case of projecting a video having the VGA resolution of 640×480, the scanning mirror 170 can completely form a two-dimensional video having the resolution of 640×480 by scanning a vertical or horizontal scanning line (i.e. a modulation beam) having information related to 480 pixels.

In this case, while the scanning mirror 170 performs the scanning from one side to the other side of the screen 190, the one-dimensional optical modulator 130 can perform the modulation at 640 times in order to form a full video of 640×480 pixels. However, the time (i.e. a scanning period) taken when the scanning is performed from one side to the other side of the screen 190 may be required to be equal to or smaller than 1/20 sec, which is the time resolution of HSV.

The one-dimensional optical modulator 130 included in the projection display apparatus in accordance with an embodiment of the present invention, however, can perform 640 modulations twice in 1/20 second, and the scanning mirror 170 can perform the scanning twice the speed.

In other words, it can be possible to project the same video onto the screen 190 twice. However, since the human time resolution is 1/20 second according to HSV, even though two identical frames are overlapped on the screen 190, a human may not recognize the overlap.

In this case, the polarization rotating unit 170 included in the projection display apparatus in accordance with an embodiment of the present invention can rotate the polarization direction every 1/40 second. Accordingly, even though the same frame is overlapped in 1/20 second with different polarization directions, this may have no effect on RGB pixels of the video, and the speckle noises can be suppressed by \sqrt{2} times by allowing uncorrelated beams to be overlapped at the same position in the screen 190. The period of rotating the polarization direction can be controlled by the polarization driver circuit 155. In particular, the polarization driver circuit 155 can control the polarization direction to be rotated, synchronously with control of the light source 100 and the optical modulator 130 by being connected to a circuit (not shown) controlling the optical modulator 130 or a host process (not shown) of the display apparatus.

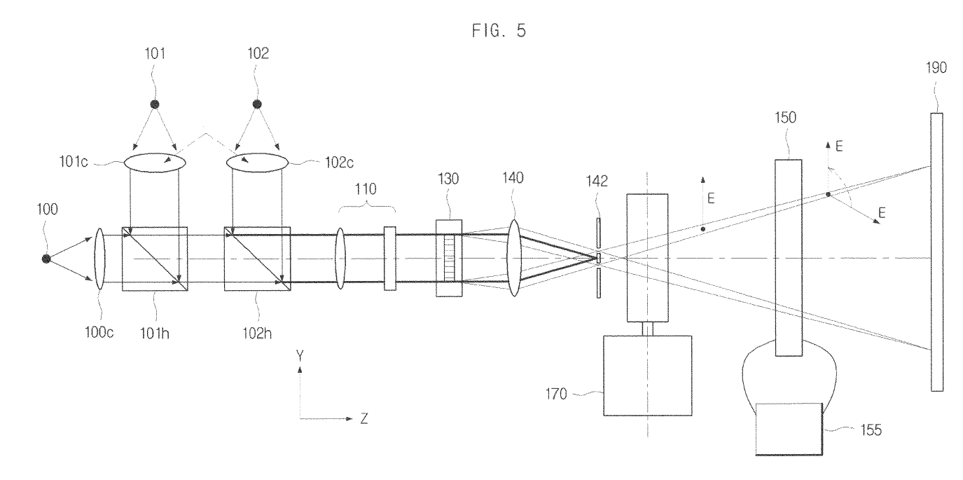

FIG. 5 shows the structure of a projection display apparatus in accordance with another embodiment of the present invention.

As shown in FIG. 5, the projection display apparatus can further include three color light sources as compared with the projection display apparatus in FIG. 4.

The three color light sources can be a green laser diode 100, a red laser diode 101, and a blue laser diode 102. The order of arranging the color light sources 100, 101, and 102 is merely an embodiment of the present invention. The arrangement can be varied according to the corresponding configuration.

The projection display apparatus in accordance with another embodiment of the present invention employs one 1-dimensional optical modulator. Accordingly, the green laser diode 100, the red laser diode 101, and the blue laser diode 102 may be required to successively output each corresponding beam according to a predetermined order.

For example, a red beam, a green beam, and a blue beam can be outputted in the aforementioned order. Accordingly, beams of light can be outputted in the order of RGB, RGB, RGB, . . . , RGB.

Similarly, his is merely an embodiment for describing the projection display apparatus of the present invention. The order of outputting the beams can be varied by some factors. For example, in case that the output of the red laser diode is lower than that of the blue or blue laser diode, the red diode laser diode 101 can consecutively output a red beam twice, and then the green laser diode 100 and the blue laser diode can successively output corresponding beams in the aforementioned order. In this case, beams of light can be outputted in the order of RRGB, RRGB, RRGB, . . . , RRGB.

The case that beams of light can be outputted in the order of RRGB, RRGB, RRGB, . . . , RRGB will be described below for the convenience of description. It is also assumed that the time that it takes for each beam to be outputted is 1/240 second.

Once the red beam, the red beam, the green beam, and the blue beam are outputted in the aforementioned order, each of the outputted beams can be orderly incident on the optical modulator 130 through the lens unit 110. The blue laser diode and the red laser diode as well as the green laser diode can be reflected by an optical device such as a half mirror 101h and 102h and pass through a cylinder lens due to the configuration before being incident on the one-dimensional optical modulator 130. Moreover, the light sources 100, 101, and 102 can include collimating lens 100c, 101c, and 102c, respectively.

Firstly, the red beam can be outputted and be incident on the one-dimensional optical modulation 130 in 1/240 second. The one-dimensional optical modulator 130 can perform 640 modulations in 1/240 second. As a result, the one-dimensional optical modulator 130 can modulate a one-dimensional modulation beam in units of 480 pixels 640 times in order to form a video having 640×480 pixels.

The modulation beam can scanned from one side to the other side of the screen 190 in 1/240 second by passing through the diaphragm 142 via the projection lens 140 and by being reflected by the scanning mirror 170. Accordingly, a red video of 640×480 pixels can be projected onto the screen 190 in 1/240 second.

Thereafter, the red laser diode 101 can be turned off, and the green laser diode 100 can be turned on. A green beam can be outputted in 1/240 second. Similar to the aforementioned red video, a green video can be projected onto the screen 190.

Then, if a blue beam is outputted from the blue laser diode 102, a blue video can be projected onto the screen 190 in 1/240 second.

As a result, the red, red, blue, and green videos can be projected onto the screen 190 in 1/60 second ( 1/240×4). While the red, red, blue, and green videos are projected onto the screen 190, the modulations that are performed by the one-dimensional optical modulator 130 may be different from each other. In other words, the video projected onto the screen 190 is the video of 640×480 pixels. Since RGB values of each pixel is independent, the modulations can be differently performed in each 1/240 second when the red, red, green, and blue beams, respectively, are incident on the screen 190. However, the red beam is weak such that the red beam is outputted twice, and when the red beam is outputted twice in 1/120 ( 1/20×2), the same modulation can be performed.

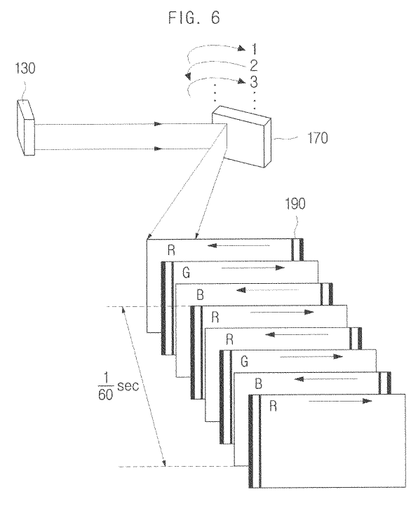

This will be described below in more detail with reference to FIG. 6.

FIG. 6 briefly shows how a projection display apparatus projects a full-color video on a screen in accordance with an embodiment of the present invention. The other elements are omitted except for the one-dimensional optical modulator 130 and the scanning mirror 170.

Firstly, if the one-dimensional optical modulator 130 receives a red beam and outputs a one-dimensional linear modulation beam having 480 vertical pixels, the scanning mirror 170 can be rotated to reflect the one-dimensional linear modulation beam to project it onto the screen 190. Accordingly, the one-dimensional linear modulation beam having 480 pixels can be scanned from a right side to a left side of the screen 190, thereby allowing a red video to be projected onto the screen 190.

Thereafter, the one-dimensional optical modulator 130, which has been received a green beam, can output a one-dimensional linear modulation beam having 480 vertical pixels, the scanning mirror 170 can be rotated to reflect the one-dimensional linear modulation beam to project it onto the screen 190. The scanning mirror 170, however, can be rotated from the left side to the right side to perform the scanning in the reverse direction of the case of the red beam. Here, the one-dimensional linear modulation beam can be scanned in a single direction only according to the determined rotating direction of the scanning mirror 170. The scanning mirror 170 may be required to be rotated twice for each time the beam is scanned.

As described above, the one-dimensional modulation beams can be projected onto the screen 190 in the order of red, green, blue, red, red, green, blue beams . . . . One set of red, red, green, and blue beams can be scanned in 1/60 second. Accordingly, three sets of red, red, green, and blue beams can be scanned onto the screen 190 in 1/20 second.

If the time resolution of HVS is assumed to be 1/20 second, even through each full-color video frame is scanned onto the screen 190 in 1/20 second, a human may not recognize this scanning.

Accordingly, the projection display apparatus in accordance with another embodiment of the present invention can allow the same full-color video frame to be overlapped on the screen 190 in 1/20 second ( 1/60×3) by identically scanning the 3 sets to the screen 190. However, since the same modulation beams are required to be overlapped at the same position, the beam of each color may be required to be identically modulated such that the one-dimensional optical modulator 130 is synchronized with the scanning mirror 170 per each set (RRGB) in order that the identically modulated beams can be projected onto the same position of the screen 190.

In this case, the projection display apparatus in accordance with another embodiment of the present invention can rotate the polarization directions E of the modulation beams of each set such that the polarization directions E are orthogonal with each other.

In other words, the projection display apparatus in accordance with another embodiment of the present invention can include the polarization rotating unit 150 to be placed between the scanning mirror 170 and the screen 190 in order to rotate the polarization directions of the modulation beams of each set. The polarization rotating unit 150 can be the liquid crystal polarization rotating unit, and the period of rotating the polarization direction can be 1/60 second in the aforementioned example. However, the period is not limited to 1/60 second. The polarization driver circuit 155 can control the modulation beams which are overlapped on the screen 190 to be repeatedly rotated in a predetermined period.

Accordingly, one-dimensional red, red, green, and blue modulation beams, which have been polarized in the vertical (i.e. 12 o'clock-6 o'clock) direction, can be projected onto the screen 190. Then, the identically modulated one-dimensional red, red, green, and blue modulation beams can be polarized in the horizontal (.e. 9 o'clock-3 o'clock) direction again before being projected onto the screen 190.

As a result, at least two videos of 3 sets of the same videos to be projected onto the screen 190 in 1/20 second can be formed by allowing uncorrelated beams to be overlapped. Therefore, the speckle noises can be suppressed by \sqrt{2} times.

It is merely an embodiment of the present invention that the polarization direction is rotated per each set while the aforementioned one-dimensional red, red, green, and blue modulation beams of 3 sets are projected onto the screen 190. Even when the one-dimensional red, red, green, and blue modulation beams of 2 sets are scanned to the screen 190, the polarization directions can be rotated identically per set.

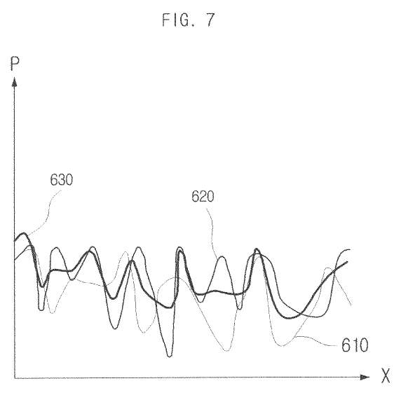

FIG. 7 is a graph showing how speckle noises are suppressed in a projection display apparatus in accordance with the present invention.

In FIG. 7, there is depicted a graph showing 3 beam magnitudes. The vertical axis of the graph refers to the beam magnitude, and the horizontal axis refers to the length of a screen. The graph shows the distributions of the beam magnitudes measured at the distance of 3 m after a video is projected onto the screen 190 by using the projection display apparatus in accordance with the present invention.

A first beam magnitude distribution 610 shows the speckle pattern on the screen 190 in case that a vertically polarized beam is scanned to the screen 190. A second beam magnitude distribution 620 shows the speckle pattern on the screen 190 in case that a horizontally polarized beam is scanned to the screen 190.

Finally, a third beam magnitude distribution 630 shows the speckle pattern on videos overlapped by allowing a vertically polarized beam to be scanned to the screen 190 and a horizontally polarized beam to be scanned to the screen 190 in a time resolution of HVS.

According to the graph, it can be said that the fluctuation of the third beam magnitude 630 is reduced as compared with those of the first magnitude distribution 610 and the second magnitude distribution 620. The point that the fluctuation of the beam magnitude distribution is reduced shows that if the same beams having orthogonal polarization directions are scanned to the screen 190, the corresponding speckle noises are suppressed.

Accordingly, if the projection display apparatus in various embodiments of the present invention, described with reference to FIG. 1A through FIG. 5, is used, the speckle noises on the screen 190 can be suppressed by \sqrt{2} times.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

1. A projection display apparatus, comprising:
a light source;
an optical modulator, configured to repeatedly output a modulation beam N times in a predetermined time range, the modulation beam being generated by identically modulating a bema of light emitted from the light source and N being a nature number and equal to or greater than 2;
a mirror, configured to reflect the modulation beam, which is repeatedly outputted N times, to scan the modulation beam to an identical point of a screen; and
a polarization rotating unit, configured to rotate a polarization direction of the modulation beam for each time the modulation beam is scanned.

2. The apparatus of claim 1, wherein the predetermined time range is smaller than a time resolution of a human vision system (HVS).

3. The apparatus of claim 1, wherein the optical modulator is a one-dimensional optical modulator that outputs a linear modulation beam, and
the mirror is a scanning mirror that forms a two-dimensional video by scanning a linear modulation beam, repeatedly outputted N times, to the screen,
whereas the polarization rotating unit rotates a polarization direction of the linear modulation beam for each time the linear modulation beam is scanned.

4. The apparatus of claim 1, wherein the light source comprises a red light source, a green light source, and a blue light source, and
the red, green, and blue light sources output each beam according to a predetermined order.

5. The apparatus of claim 4, wherein the light source outputs beams at a period of a set of beams consisting of a red beam, a green beam, and a blue beam at least once; and
the optical modulator outputs the modulation beam by modulating the beams N times identically at the period of a set of beams,
whereas the polarization rotating unit rotates a polarization direction of the modulation beam at the period of a set of beams.

6. The apparatus of claim 5, wherein, if the modulation beam, which is outputted by identically modulating the beams N times at the period of the set of beams, is scanned to an identical point of the screen, a full-color video frame is completely formed.

7. The apparatus of claim 5, wherein a multiple of the N of the period of the set of beams is smaller than a period of a human time resolution.

8. The apparatus of claim 1, wherein the polarization rotating unit is a liquid crystal polarization rotating unit.

9. The apparatus of claim 1, wherein the polarization rotating beam is placed between the mirror and the screen.
